(19) United States
(12) Patent Application Publication
(10) Pub. No.: US 2026/0068955 A1
(43) Pub. Date: Mar. 12, 2026

(54) AEROSOL GENERATING DEVICE

(71) Applicant: KT&G CORPORATION, Daejeon (KR)

(72) Inventors: Jin Chul JUNG, Daejeon (KR); Jung Ho KIM, Seoul (KR); Sang Cheol PARK, Gyeonggi-do (KR); Jang Won SEO, Gyeonggi-do (KR); Won Kyeong LEE, Gyeonggi-do (KR); Chul Ho JANG, Gyeonggi-do (KR)

(73) Assignee: KT&G CORPORATION, Daejeon (KR)

(21) Appl. No.: 19/263,303

(22) Filed: Jul. 8, 2025

(30) Foreign Application Priority Data
Sep. 12, 2024 (KR) 10-2024-0124920
Dec. 31, 2024 (KR) 10-2024-0202574

(51) Int. Cl. A24F 40/57; A24F 40/465; A24F 40/51; H05B 6/64; H05B 6/68; H05B 6/80

(52) U.S. Cl. CPC A24F 40/57; A24F 40/465; A24F 40/51; H05B 6/6458; H05B 6/686; H05B 6/80

(57) ABSTRACT

An aerosol generating device includes a source unit configured to generate a radio frequency (RF) signal, a radiating unit configured to heat the aerosol generating article by radiating the RF signal in a form of electromagnetic waves to an insertion space into which an aerosol generating article is inserted, a sensing unit configured to detect a change in moisture of the aerosol generating article according to the heating by the radiating unit, and a control unit configured to control a frequency and a power of the RF signal output by the source unit, based on the change in moisture of the aerosol generating article.

### CROSS-REFERENCE TO RELATED APPLICATION

This application is based on and claims priority under 35 U.S.C. § 119 to Korean Patent Application No. 10-2024-0124920, filed on Sep. 12, 2024, in the Korean Intellectual Property Office, and Korean Patent Application No.10-2024-0202574, filed on Dec. 31, 2024, in the Korean Intellectual Property Office, the disclosures of which are incorporated by reference herein in their entirety.

### BACKGROUND

### 1. Field

The disclosure relates to an aerosol generating device, and more particularly, to an aerosol generating device which may adjust an output of microwaves according to a moisture level of an aerosol generating article.

### 2. Description of the Related Art

Recently, there has been an increasing demand for alternative methods to overcome the shortcomings of general cigarettes. For example, there is an increasing demand for a system that generates aerosols by heating a cigarette (or an aerosol generating article), rather than a method of generating aerosols by burning a cigarette

In aerosol generating devices according to the related art, aerosol generating articles are heated by a resistance heating method, an induction heating method, or an ultrasound heating method. However, aerosol generating devices in the art have a slow preheating speed and non-uniform heating, as compared with a dielectric heating method.

Furthermore, while some of the aerosol generating devices in the art use a dielectric heating method, in this dielectric heating method, a matching frequency is tracked according to consumption of aerosol generating substances (for example, moisture etc.), without a separate moisture detection sensor, and an output of an oscillator is controlled with only the matching frequency. As this method only considers optimal heating efficiency without considering the user's actual smoking flavor sensation, user satisfaction may be lowered.

### SUMMARY

Provided is an aerosol generating device which may obtain the absolute value of a moisture content included in an aerosol generating article through a separate moisture detection sensor and adjust an output of microwaves based on an output of the moisture content, by using a dielectric heating method.

The technical objectives to be achieved by the disclosure are not limited to the above-described objectives, and other technical objectives may be inferred from the following embodiments.

Additional aspects will be set forth in part in the description which follows and, in part, will be apparent from the description, or may be learned by practice of the presented embodiments of the disclosure.

According to an aspect of the disclosure, an aerosol generating device includes a source unit configured to generate a radio frequency (RF) signal, a radiating unit configured to heat the aerosol generating article by radiating the RF signal in a form of electromagnetic waves to an insertion space into which an aerosol generating article is inserted, a sensing unit configured to detect a change in moisture of the aerosol generating article according to the heating by the radiating unit, and a control unit configured to control a frequency and a power of the RF signal output by the source unit based on the change in moisture of the aerosol generating article.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an aerosol generating device according to an embodiment;

FIG. 2 is a block diagram of an aerosol generating device according to an embodiment;

FIG. 3 is a block diagram for explaining operation of a dielectric heating unit, according to an embodiment;

FIG. 4 is a cross-sectional view of a heater assembly for describing the arrangement of a sensing unit and an antenna, according to an embodiment;

FIG. 5 is a cross-sectional view of a heater assembly for describing the arrangement of a sensing unit and an antenna, according to another embodiment.

FIG. 6 is a graph for explaining a power control method and a frequency of a source unit corresponding to a change in the moisture level of an aerosol generating article, according to an embodiment;

FIG. 7 is a graph showing an example of a heating profile for explaining a method of controlling a frequency and a power of a source unit in a partial section of a preheating section, according to an embodiment; and

FIG. 8 is a flowchart for explaining an operation method of an aerosol generating device, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 15) readable by a machine (e.g., an aerosol generating device 1). For example, a processor (e.g., a control unit 10) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

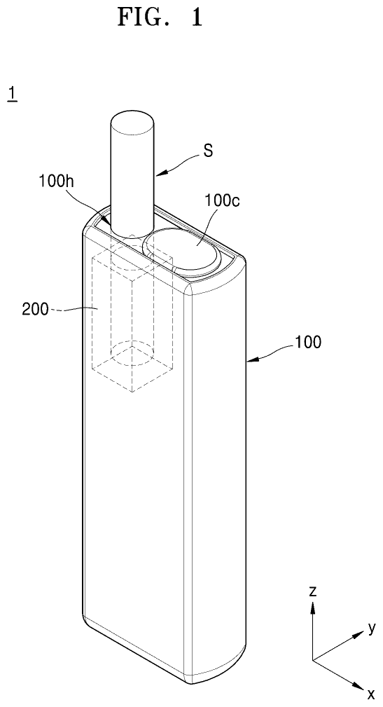

FIG. 1 is a perspective view of an aerosol generating device 1 according to an embodiment.

Referring to FIG. 1, the aerosol generating device 1 according to an embodiment may include a housing 100 for accommodating an aerosol generating article S and a heater assembly 200 for heating the aerosol generating article S accommodated in the housing 100.

The housing 100 may form the overall exterior of the aerosol generating device 1, and the components of the aerosol generating device 1 may be arranged in an inner space (or amounting space) of the housing 100. For example, the heater assembly 200, a battery, a processor, and/or a sensor may be arranged in the inner space of the housing 100, but the components arranged in the inner space are not limited thereto.

An insertion space 100h may be defined in one area of the housing 100, and at least one area of the aerosol generating article S may be inserted into the housing 100 through the insertion space 100h. For example, the insertion space 100h may be defined in an area on an upper surface (e.g.: a surface facing a z direction) of the housing 100, but the position where the insertion space 100h is defined is not limited thereto. In another embodiment, the insertion space 100h may be defined in an area of a side surface (e.g.: a surface facing an x direction) of the housing 100.

The heater assembly 200 may be arranged in the inner space of the housing 100, and may heat the aerosol generating article S inserted or accommodated in the housing 100 through the insertion space 100h. For example, the heater assembly 200 may surround the at least one area of the aerosol generating article S inserted or accommodated in the housing 100 to heat the aerosol generating article S.

According to an embodiment, the heater assembly 200 may heat the aerosol generating article S by a dielectric heating method. In the disclosure, the term “dielectric heating method” may mean a method of heating a dielectric that is an object to be heated, by using an electromagnetic wave in a microwave wavelength. Microwaves are an energy source for heating an object to be heated and are generated by high-frequency power. Therefore, the microwaves may be used below interchangeably with microwave power.

In the heater assembly 200, electric charges or ions contained inside the aerosol generating article S may vibrate or rotate due to the microwaves, and heat may be generated in the dielectric by frictional heat generated in the process in which the electric charges or ions vibrate or rotate, thereby heating the aerosol generating article S.

As the aerosol generating article S is heated by the heater assembly 200, aerosols may be generated from the aerosol generating article S. In the disclosure, the term “aerosols” may mean particles in a gas generated by mixing air and vapor that is generated as the aerosol generating article S is heated.

The aerosol generated from the aerosol generating article S may pass through the aerosol generating article S or may be discharged to the outside of the aerosol generating device 1 through an empty space between the aerosol generating article S and the insertion space 100h. A user may smoke by contacting an oral cavity to one area of the aerosol generating article S exposed to the outside of the housing 100, and sucking aerosols discharged to the outside of the aerosol generating device 1.

The aerosol generating device 1 according to an embodiment may further include a cover 100c that is movably arranged on the housing 100 to open or close the insertion space 100h. For example, the cover 100c may be slidably coupled to the upper end surface of the housing 100 so as to expose the insertion space 100h to the outside of the aerosol generating device 1 or may cover the insertion space 100h to prevent the insertion space 100h from being exposed to the outside of the aerosol generating device 1.

In an example, the cover 100c may expose the insertion space 100h to the outside of the aerosol generating device 1 at a first position (or an “open position”). When the aerosol generating device 1 is exposed to the outside, the aerosol generating article S may be inserted into the housing 100 through the insertion space 100h.

In another example, the cover 100c covers the insertion space 100h at a second position (or a “closed position”), and thus the insertion space 100h may not be exposed to the outside of the aerosol generating device 1. In this state, when the aerosol generating device 1 is not used, the cover 100c may prevent external foreign materials from being introduced into the heater assembly 200 through the insertion space 100h.

Although FIG. 1 illustrates only the aerosol generating device 1 for heating the aerosol generating article S in a solid state, the aerosol generating device 1 is not limited to the embodiment illustrated in the drawing.

According to another embodiment, the aerosol generating device 1 may generate aerosols through the heater assembly 200 by heating an aerosol generating substance in a liquid or gel state, not the aerosol generating article S in a solid state.

According to another embodiment, the aerosol generating device 1 may include the heater assembly 200 for heating the aerosol generating article S and a cartridge (or a “vaporizer”) containing an aerosol generating substance in a liquid or gel state and heating the aerosol generating substance. The aerosols generated from the aerosol generating substance may be moved to the aerosol generating article S along a flow path that communicates between the cartridge and the aerosol generating article S, and then mixed with the aerosols generated from the aerosol generating article S and transferred to a user by passing through the aerosol generating article S.

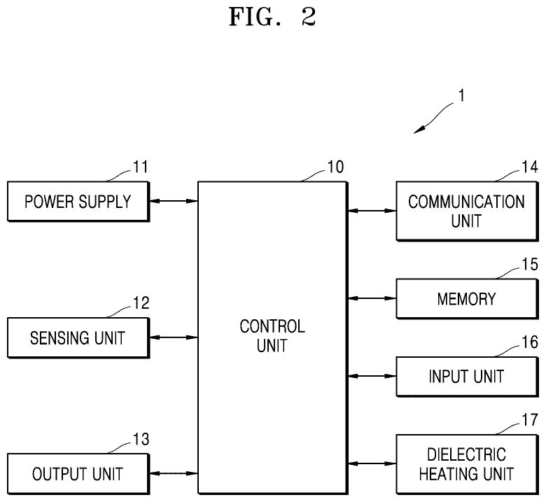

FIG. 2 is a block diagram of the aerosol generating device 1 according to an embodiment.

According to an embodiment, the aerosol generating device 1 may include a power supply 11, a control unit 10, a sensing unit 12, an output unit 13, an input unit 16, a communication unit 14, a memory 15, and/or a dielectric heating unit 17. However, according to the design of the aerosol generating device 1, it will be understood by those skilled in the art related to the present embodiment that some of the components illustrated in FIG. 1 may be omitted or new components may be added.

The sensing unit 12 may detect the conditions of the aerosol generating device 1 or the conditions around the aerosol generating device 1, and transmit the detected information to the control unit 10. For example, the sensing unit 12 may include a temperature sensor, a puff sensor, an insertion detection sensor, a reuse detection sensor, a cigarette identification sensor, a cartridge detection sensor, a cap detection sensor, and/or a motion detection sensor. The sensing unit 12 may further include various sensors, such as a liquid level sensor for detecting a remaining amount of a liquid in the cartridge or a submersion sensor for detecting submersion of the aerosol generating device 1.

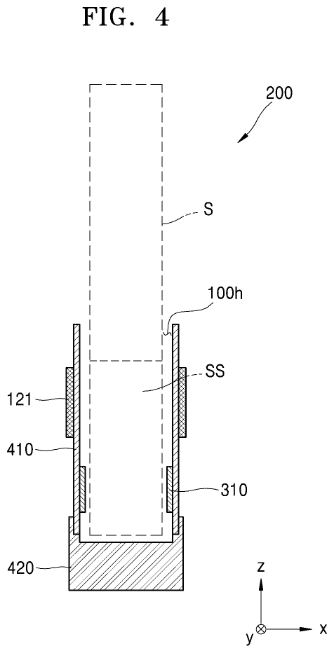

In an embodiment, the sensing unit 12 may include a moisture detection sensor 121 in FIG. 4. The moisture detection sensor 121 may detect a change in moisture in the insertion space 100h. As moisture (e.g., vegetable glycerin) of the aerosol generating article S contributes the most to a moisture content within the insertion space 100h, that the moisture detection sensor 121 detects the change in the moisture in the insertion space 100h may mean the same as saying that the moisture detection sensor 121 detects the change in the moisture of the aerosol generating article S inserted into the insertion space 100h.

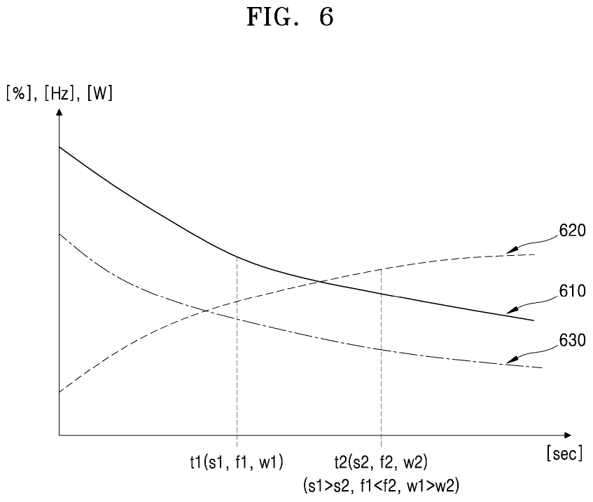

The moisture detection sensor 121 may include a capacitance-based sensor. In the disclosure, the capacitance-based sensor may also be referred to as a capacitive sensor. The capacitive sensor may be arranged adjacent to the insertion space 100h, and permittivity of the capacitive sensor may vary depending on the change in the moisture of the aerosol generating article S. The control unit 10 may receive a detection result from the moisture detection sensor 121 and control the dielectric heating unit 17 based on the detection result. A control method according to the change in the moisture of the aerosol generating article S is described below with reference to FIG. 6 and below.

The control unit 10 may determine whether the aerosol generating article S has been inserted based on the change in the moisture in the insertion space 100h. When the aerosol generating article S is inserted into the insertion space 100h, the permittivity of the moisture detection sensor 121 may vary. The control unit 10 may determine whether the aerosol generating article S has been inserted based on the change in permittivity of the moisture detection sensor 121. In an example where the control unit 10 determines the insertion of the aerosol generating article S based on the change in the moisture in the insertion space 100h, the moisture detection sensor 121 may function as the insertion detection sensor described above.

Furthermore, the control unit 10 may identify the aerosol generating article S based on the change in the moisture in the insertion space 100h. The aerosol generating article S may have a unique moisture content range, and the control unit 10 may identify the aerosol generating article S based on the unique moisture content range. In an example where the control unit 10 identifies a type of the aerosol generating article S based on the change in the moisture in the insertion space 100h, the moisture detection sensor 121 may function as the cigarette identification sensor described above.

The output unit 13 may output information about the conditions of the aerosol generating device 1. The output unit 13 may include a display, a haptic unit, and/or a sound output unit, but the disclosure is not limited thereto. For example, the information about the aerosol generating device 1 may include a charging/discharging state of the power supply 11 of the aerosol generating device 1, a preheating state of the dielectric heating unit 17, an insertion/removal state of the aerosol generating article and/or the cartridge, a mounting and/or removal state of the cap, or a state (e.g.: abnormal article detection) in which use of the aerosol generating device 1 is restricted. The display may visually provide a user with the conditions of the information about the aerosol generating device 1. For example, the display may include a light-emitting diode (LED) element, a liquid crystal display (LCD) panel, or an organic light-emitting display (OLED) panel. The display, when including a touch pad, may be used as the input unit 16. The haptic unit may provide a user with the conditions of the information about the aerosol generating device 1, in a tactile manner. For example, the haptic unit may include a vibration motor, a piezoelectric element, or an electrical stimulation device. The sound output unit may provide a user with the information about the aerosol generating device 1, in an audible manner. For example, the sound output unit may convert an electrical signal into an acoustic signal and output the converted signal to the outside.

The power supply 11 may supply power for the operation of the aerosol generating device 1. The power supply 11 may include one or more batteries. The power supply 11 may supply power for the dielectric heating unit 17 to operate. Furthermore, the power supply 11 may supply power needed for the operations of other components included in the aerosol generating device 1, such as the control unit 10, the sensing unit 12, the output unit 13, the input unit 16, the communication unit 14, and the memory 15. The power supply 11 may include a chargeable battery or a disposable battery. For example, the power supply 11 may include a lithium polymer (LiPoly) battery, but the disclosure is not limited thereto. The power supply 11 may include a replaceable type (a separation type) battery (hereinafter, referred to as the detachable battery). The detachable battery may be mounted in a battery accommodation portion provided within the aerosol generating device 1, or removed from the battery accommodation portion. The detachable battery may be charged in a wired and/or wireless manner.

The dielectric heating unit 17 may heat the aerosol generating article S by the dielectric heating method. The dielectric heating unit 17 may include some components of the heater assembly 200 of FIG. 1. The dielectric heating unit 17 may heat the aerosol generating article S by using an electromagnetic wave in a microwave wavelength. The heating method by the dielectric heating unit 17 may include a microwave radiation method or a microwave resonance method. The dielectric heating unit 17 may output high-frequency microwaves to the insertion space 100h. The microwaves may be power in an industrial scientific and medical equipment (ISM) band permitted for heating, but the disclosure is not limited thereto.

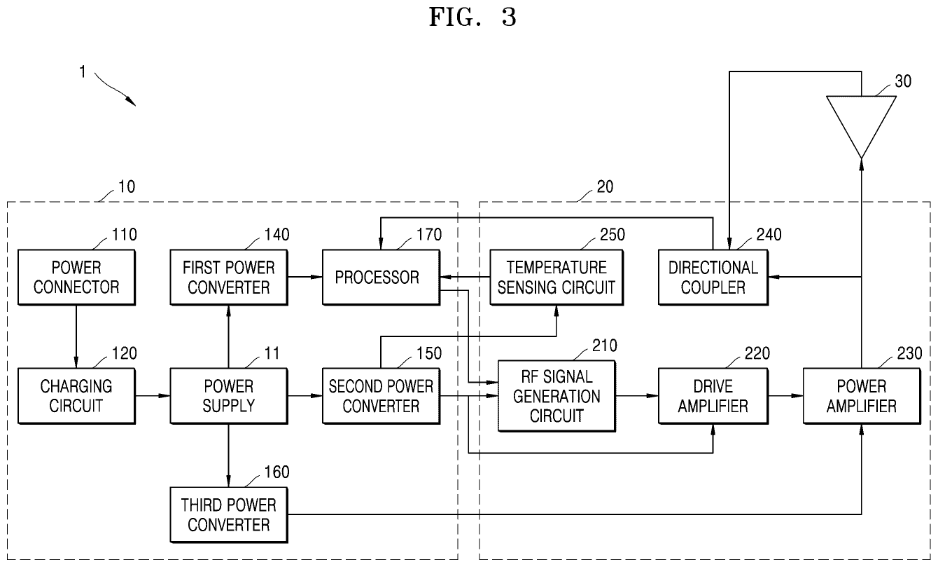

The aerosol generating article S may be inserted in the insertion space 100h, and a dielectric material in the aerosol generating article S may be heated by the microwaves. For example, the aerosol generating article S may include a polar material, and molecules in the polar material may be polarized within the insertion space 100h. The molecules may vibrate or rotate due to a polarization phenomenon, and the aerosol generating article S may be heated by frictional heat generated in the process. An operation method of the dielectric heating unit 17 is described below in detail with reference to FIG. 3.

The input unit 16 may receive information input by a user. For example, the input unit 16 may include a touch panel, a button, a key pad, a dome switch, a jog wheel, or a jog switch.

The memory 15 is hardware for storing various pieces of data that are processed within the aerosol generating device 1 and may store the pieces of data processed or to be processed in the control unit 10. For example, the memory 15 may include at least one type of storage media of a flash memory type, a hard disk type, a multimedia card micro type, or a card type memory (e.g., SD or XD memory, etc.), random access memory (RAM), static random access memory (SRAM), read-only memory (ROM), electrically erasable programmable read-only memory (EEPROM), programmable read-only memory (PROM), a magnetic memory, a magnetic disk, or an optical disk. For example, the memory 15 may store the operation time of the aerosol generating device 1, the maximum number of puffs, a current number of puffs, at least one temperature profile, and data about user's smoking pattern.

The communication unit 14 may include at least one component for communicating with other electronic devices (e.g.: a portable electronic device). For example, the communication unit 14 may include a Bluetooth communication unit, a Bluetooth low energy (BLE) communication unit, a near field communication unit, a wireless local area network (WLAN) communication unit, a Zigbee communication unit, an infrared data association (IrDA) communication unit, a wireless fidelity direct (WFD) communication unit, an ultra-wideband (UWB) communication unit, an adaptive network topology (Ant)+ communication unit, a cellular network communication unit, an Internet communication unit, or a computer network (e.g.: LAN or WAN) communication unit.

The control unit 10 may control the overall operation of the aerosol generating device 1. For example, the control unit 10 may include at least one processor 170 in FIG. 3. The control unit 10 may be implemented as an array of multiple logic gates or as a combination of a general purpose microcontrol unit (MCU) (or a microprocessor) and a memory storing a program to be executed on the MCU. Furthermore, it will be understood by those skilled in the art to which the present embodiment pertains that the embodiment may be implemented in other forms of hardware.

According to an embodiment, the control unit 10 may control the temperature of the dielectric heating unit 17 by controlling the output of microwaves frequency and output power. The control unit 10 may control the temperature of the dielectric heating unit 17 and/or the power supplied to the dielectric heating unit 17, based on the temperature of the dielectric heating unit 17 detected by using a temperature sensor (e.g.: the sensing unit 12). The control unit 10 may control the temperature of the dielectric heating unit 17 and/or the power supplied to the dielectric heating unit 17 based on the temperature profile and/or power profile stored in the memory 15.

According to an embodiment, the control unit 10 may control the power supply to the dielectric heating unit 17 based on the result of the detection by the sensing unit 12. Furthermore, the control unit 10 may control the output unit 13 based on the result of the detection by the sensing unit 12. For example, when the number of puffs counted by using a puff sensor (e.g.: the sensing unit 12) reaches a preset number, the control unit 10 may control the output unit 13 to provide a user with information that the aerosol generating device 1 will stop soon, in a visual, tactile and/or audible manner. For example, the control unit 10 may control the output unit 13 to provide a user with information about the temperature of the dielectric heating unit 17, in a visual, tactile, and/or audible manner.

Based on an occurrence of a certain event, the control unit 10 may store and update a history of the event that has occurred in the memory 15. For example, the event may include detecting insertion of an aerosol generating article, starting heating of an aerosol generating article, detecting a puff, ending a puff, detecting overheat of the dielectric heating unit 17, detecting application of overvoltage to the dielectric heating unit 17, ending heating of an aerosol generating article, an operation of turning on/off of the aerosol generating device 1, starting charging of the power supply 11, detecting overcharge of the power supply 11, or ending charging of the power supply 11, which are performed in the aerosol generating device 1.

According to an embodiment, the control unit 10 may control the communication unit 14 to establish a communication link with an external device such as a users' mobile terminal.

According to an embodiment, when receiving data about authentication from an external device through a communication link, the control unit 10 may remove restrictions on usage of at least one function (e.g.: a heating function) of the aerosol generating device 1. For example, the data about authentication may include user's birthday, a unique number that identifies the user, and whether the user has completed authentication.

According to an embodiment, the control unit 10 may transmit data about the conditions of the aerosol generating device 1 (e.g.: the remaining capacity of the power supply 11, an operation mode, etc.) to the external device through the communication link. The transmitted data may be output through a display of the external device.

The aerosol generating article S stated in the disclosure may include at least one aerosol generation rod (e.g.: a medium part) and at least one filter rod. The dielectric heating unit 17 may be arranged to correspond to the at least one aerosol generation rod, and may be designed differently according to the arrangement order and/or position of the aerosol generation rod and the filter rod. The aerosol generation rod may include at least one of nicotine, an aerosol generating substance, and additives. For example, the aerosol generating substance may include glycerin (e.g.: vegetable glycerin (VG)) and/or propylene glycol (PG), and various other materials. For example, the additives may include a flavoring agent and/or an organic acid, and various other materials. For example, the aerosol generation rod may include an aerosol generation substrate (e.g.: sheet) impregnated with a non-tobacco material in a liquid state (e.g.: an aerosol generating substance and/or nicotine), and/or a tobacco material in a solid state (e.g.: a leaf tobacco, a reconstructed tobacco, etc.). The tobacco material may be included in the aerosol generation rod in various forms, such as shredded leaves, granules, or powder. According to an embodiment, the additives of the aerosol generation rod may include a basic material. The nicotine of a tobacco material included in the aerosol generation rod may have a basic pH (e.g.: pH 7.0 or more) based on the basic material. In this case, even at a low temperature, freebase nicotine may be emitted from the aerosol generation rod. According to an embodiment, the aerosol generation rod may include two or more aerosol generation rods, and the two or more aerosol generation rods may include a tobacco material and/or a non-tobacco material. Although not illustrated, at least one aerosol generation rod and at least one filter rod may be individually and/or collectively wrapped by at least one wrapper. In the disclosure, the aerosol generating article may be referred to as a stick.

FIG. 3 is a block diagram for explaining operation of a dielectric heating unit, according to an embodiment.

Referring to FIG. 3, the aerosol generating device 1 may include a control unit 11, a source unit 20, and a radiating unit 30. The source unit 20 and the radiating unit 30 of FIG. 3 may comprise a portion of the dielectric heating unit 17 of FIG. 2. The control unit 10 may refer to a circuit for controlling the basic operation of the aerosol generating device 1. The source unit 20 may refer to a circuit for generating a radio frequency (RF) signal under the control by the control unit 10. The radiating unit 30 may be a device for radiating an RF signal generated by the source unit 20 in the form of electromagnetic waves into a space into which an aerosol-generating article is inserted (hereinafter, “insertion space 100h”). Charges or ions of a dielectric (e.g., glycerin) included in an aerosol-generating article may vibrate or rotate due to radiated electromagnetic waves (e.g., RF signals), and the aerosol-generating article may be heated as the dielectric generates heat due to frictional heat generated in the process of the charges or ions vibrating or rotating. In other words, the aerosol generating device 1 may be a device that generates an aerosol by heating an aerosol-generating article in a dielectric heating manner.

In an embodiment, the control unit 10 may include a power connector 110, a charging circuit 120, a power supply 11, a first power converter 140, a second power converter 150, a third power converter 160, and/or a processor 170. Additionally, the source unit 20 may include an RF signal generation circuit 210, a drive amplifier 220, a power amplifier 230, a directional coupler 240, and/or a temperature sensing circuit 250. However, it will be understood by those skilled in the art related to the present embodiment that some of the components illustrated in FIG. 3 may be omitted or new components may be added according to the design of the aerosol generating device 1.

The power connector 110 may refer to a physical connection device that is electrically connected to an electronic device or system (e.g., an external power supply) outside the aerosol generating device 1 and used to transmit and receive power. For example, the power connector 110 may receive power from an external power supply and transmit the received power to a component requiring charging (e.g., the power supply 11). The power connector 110 may also provide a path for data transmission. In this case, the power connector 110 may be referred to as a data and power connector. The aerosol generating device 1 may transmit and receive data to or from an external electronic device or system (e.g., a smartphone, a computer, etc.) through the power connector 110. The power connector 110 may include a Universal Serial Bus (USB) power connector, a direct current (DC) power connector, etc. In an example, the power connector 110 may include, but is not limited to, a USB-C type connector capable of supplying 9 V of direct current (DC) voltage at a current of 1 A. The power connector 110 may also include an interface for transmitting and receiving power wirelessly.

The charging circuit 120 may refer to a circuit for charging the power supply 11. The charging circuit 120 may charge the power supply 11 by using power transmitted from the power connector 110. In an example, the charging circuit 120 may be implemented as a charger IC, which is an integrated circuit (IC) that performs functions for efficiently and safely charging the power supply 11. The charging circuit 120 may monitor the charging status of the power supply 11 or optimize the charging process by monitoring the voltage, current, and/or temperature of the power supply 11. For example, the charging circuit 120 may detect the status of the power supply 11 and prevent overcharging or overdischarging by providing an appropriate charging voltage and current.

The power supply 11 may supply power to the radiating unit 30 such that the radiating unit 30 may radiate electromagnetic waves (e.g., RF signals) into the insertion space 100h to heat an aerosol-generating article. Here, power supply to the radiating unit 30 may indicate power supply to the source unit 20. Additionally, the power supply 11 may supply power required for the operation of the processor 170, the RF signal generation circuit 210, the drive amplifier 220, the power amplifier 230, the temperature sensing circuit 250, etc.

The aerosol generating device 1 may include a power conversion circuit for converting power supplied from the power supply 11 into power (e.g., voltage and/or current) suitable for other components. The power conversion circuit may include at least one of a buck converter, a buck-boost converter, a boost converter, a Zener diode, and a low-dropout (LDO) regulator. Additionally, the power conversion circuit may include a DC/AC converter (e.g., an inverter) as required.

In an example, the aerosol generating device 1 may include the first power converter 140, the second power converter 150, and the third power converter 160. The first power converter 140 may be an LDO regulator for supplying power (e.g., a DC of 3.3 V) suitable for the processor 170, the second power converter 150 may be a buck-boost converter for supplying power (e.g., a DC of 5 V) suitable for the temperature sensing circuit 250, the RF signal generation circuit 210, and the drive amplifier 220, and the third power converter 160 may be a boost converter for supplying power (e.g., a DC of 12 V/25 W) suitable for the power amplifier 230.

However, the first power converter 140, the second power converter 150, and the third power converter 160 are not limited to the examples described above and may include other types of power conversion circuits. Additionally, although FIG. 3 illustrates the aerosol generating device 1 including three power converters, the aerosol generating device 1 may include more than three power converters or may include fewer power converters. In an example, at least some of the first power converter 140, the second power converter 150, and the third power converter 160 may be integrated into a single power converter.

The processor 170 may control the overall operation of the aerosol generating device 1. For example, the processor 170 may directly or indirectly control charging and discharging of the power supply 11 by using the charging circuit 120. Additionally, the processor 170 may control the voltage and/or current output by a power conversion circuit by controlling the frequency and/or duty ratio of a current pulse input to at least one switching element of the power conversion circuit. In addition to the components described above, the processor 170 may also control the overall operation of other components to be described later.

The processor 170 may be implemented as an array of multiple logic gates, or may be implemented as a combination of a general-purpose microcontrol unit (MCU) (or microprocessor) and a memory storing a program that may be executed in the MCU. Additionally, it will be understood by those skilled in the art that the processor 170 may be implemented in other forms of hardware.

The RF signal generation circuit 210 may generate an RF signal based on power delivered from the power supply 11 or the second power converter 150. An RF signal may refer to a signal having a frequency within a range of about 300 MHz to about 300 GHz. In an example, the RF signal may have a frequency of about 1 GHz to about 100 GHz. Additionally, the RF signal may have a frequency in the Industrial Scientific and Medical equipment (ISM) band, for example, 915 MHz, 2.45 GHz, and/or 5.8 GHz.

The RF signal generation circuit 210 may include a voltage-controlled oscillator (VCO) that generates an RF signal having a different frequency depending on an input voltage. The RF signal generation circuit 210 may receive a control signal (e.g., a DC signal) from the processor 170 and generate an RF signal having a frequency corresponding to the received control signal. The processor 170 may store a control signal corresponding to a desired frequency in the form of a look-up table, or calculate a control signal corresponding to a desired frequency in real time through at least one operation.

In an example, the aerosol generating device 1 may further include a digital to analog converter (D/A converter) for converting a digital control signal output from the processor 170 into an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may provide an input signal suitable for a component of a next stage (e.g., the power amplifier 230) by amplifying the signal level (e.g., amplitude) of the RF signal. The drive amplifier 220 may minimize signal distortion by maintaining high linearity. However, since the drive amplifier 220 is an amplifier focused on increasing the signal level, the drive amplifier 220 may provide relatively low output power.

The power amplifier 230 may amplify power of an RF signal received from the drive amplifier 220. The power amplifier 230 may be an amplifier focused on providing sufficient power to a final output device (e.g., the radiating unit 30). For example, the power amplifier 230 may provide a high-power RF signal to the radiating unit 30 so that the radiating unit 30 may radiate electromagnetic waves into the insertion space 100h to heat an aerosol-generating article. The power amplifier 230 may perform an amplification operation by using power received through the third power converter 160 that provides higher power and/or voltage than the second power converter 150.

The drive amplifier 220 and the power amplifier 230 may include transistors such as a bipolar junction transistor (BJT), a field effect transistor (FET), or a vacuum tube. In an example, the drive amplifier 220 and the power amplifier 230 may be, but are not limited to, gallium nitride (GaN) transistors configured to handle high efficiency, high speed, and high voltage. The drive amplifier 220 and the power amplifier 230 may also include an operational amplifier.

In FIG. 3, the drive amplifier 220 and the power amplifier 230 are illustrated as individual amplifiers, but the drive amplifier 220 and the power amplifier 230 may be integrated into a single amplifier. Additionally, the drive amplifier 220 and/or the power amplifier 230 may be configured as a series connection, a parallel connection, and/or a combination thereof of a plurality of amplifiers.

The radiating unit 30 may include at least one antenna for radiating electromagnetic waves into space. At least one antenna may have a size and shape suitable for the size and shape of an aerosol-generating article. For example, if the aerosol-generating article is cylindrical in shape, at least one antenna may be tubular surrounding the aerosol-generating article that is cylindrical. Here, the shape of the antenna being tubular may indicate that the overall shape of the antenna is tubular. In other words, if the antenna is formed of a metal (e.g. SUS) track, this may indicate that the overall shape of the entire track is tubular. The shape of at least one antenna is not limited to the examples described above and may include various shapes such as a flat plate shape, a curved plate shape, etc.

The radiating unit 30 may heat the aerosol-generating article by radiating electromagnetic waves (e.g., an amplified RF signal or a transmitted RF signal) into the insertion space 100h. For the heating efficiency of the aerosol generating article to be maximized, resonance of electromagnetic waves is to occur within the insertion space 100h. The resonance conditions (e.g., resonant frequency) of the insertion space 100h may vary depending on the amount of dielectric contained in the inserted aerosol-generating article. The processor 170 may control the frequency of an RF signal generated by the RF signal generation circuit 210 to correspond to or be close to the resonance condition of the insertion space 100h by adjusting a control signal input to the RF signal generation circuit 210. The processor 170 may use the directional coupler 240 to obtain information about the resonance conditions of the insertion space 100h.

The directional coupler 240 may refer to a passive element having a waveguide structure that separates an incident wave and a reflected wave from each other. The directional coupler 240 may receive an RF signal transmitted from the power amplifier 230 toward the radiating unit 30 and electromagnetic waves reflected from the insertion space 100h after they are radiated by the radiating unit 30. The directional coupler 240 may separate the transmitted RF signal and the reflected electromagnetic waves, and provide them to the processor 170.

In an example, the aerosol generating device 1 may further include an analog to digital converter (A/D converter) for converting an analog output of the directional coupler 240 into a digital output. The A/D converter may be built into the processor 170 or may exist as a separate component outside the processor 170. The processor 170 may analyze the characteristics (e.g., current, voltage, power, phase, and/or frequency) of the transmitted RF signal and the characteristics (e.g., current, voltage, power, phase, and/or frequency) of the reflected electromagnetic waves by monitoring the output of the directional coupler 240.

The processor 170 may determine whether the operation of the source unit 20 is being performed as intended, based on the characteristics of the transmitted RF signal. Additionally, the characteristics of the transmitted RF signal may be used to determine the heating efficiency of the source unit 20 or the radiating unit 30, together with the characteristics of the reflected electromagnetic wave. The processor 170 may control the source unit 20 such that the heating efficiency of the source unit 20 or the radiating unit 30 is maximized. For example, the processor 170 may adjust the frequency of an RF signal generated by the RF signal generation circuit 210 such that the power of the reflected electromagnetic waves is minimized. Minimizing the power of the reflected electromagnetic waves may indicate that the frequency of the RF signal is closer to the resonance conditions of the insertion space 100h. The characteristics of the transmitted RF signal may provide a criterion for whether the power of the reflected electromagnetic waves is minimized.

Since resonance of electromagnetic waves may occur in the insertion space 100h depending on the frequency of the RF signal, the insertion space 100h may be referred to as a resonant section. At least a portion of the insertion space 100h may be surrounded by at least one shielding member to prevent electromagnetic waves from leaking outside the aerosol generating device 1. In an embodiment, the insertion space 100h may further include a physical structure to ensure that the resonance conditions are within a range controllable by the processor 170. The physical structure may include at least one conductor, and the resonance conditions of the insertion space 100h may vary depending on the arrangement, thickness, and length of the conductor. Additionally, the physical structure may include a space for accommodating a dielectric having low electromagnetic absorption, separate from the dielectric contained in the aerosol-generating article. A dielectric with low electromagnetic absorption may change the resonant frequency of the entire resonant section without absorbing the energy that is to be transferred to the heated material. Accordingly, even if the resonant section is reduced in size, the resonance conditions may be determined within a range controllable by the processor 170.

The temperature sensing circuit 250 may be arranged in contact with or adjacent to components included in the source unit 20 to measure the temperature of the source unit 20. For example, the temperature sensing circuit 250 may be arranged in contact with or adjacent to at least one of the RF signal generation circuit 210, the drive amplifier 220, and the power amplifier 230. Heat may be generated due to limited efficiency in the process of generating and/or amplifying RF signals, and if excessive heat is generated, this heat may have a negative impact on components included in the source unit 20 or other components included in the aerosol generating device 1. The temperature measured by the temperature sensing circuit 250 may be used to prevent overheating of the source unit 20.

The processor 170 may receive the temperature (or a value corresponding to the temperature) measured from the temperature sensing circuit 250, and if it is determined that the source unit 20 is overheated, the processor 70 may stop the operation of the source unit 20. For example, the processor 170 may stop the operation of the source unit 20 by cutting off the power supply to the source unit 20 or transmitting a control signal. Hereinafter, the term ‘power supply’ to the source unit 20 is used to indicate controlling whether the source unit 20 operates.

The temperature sensing circuit 250 may include at least one temperature sensor among a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied, but is not limited thereto.

FIG. 4 is a cross-sectional view of a heater assembly 200 for describing the arrangement of a sensing unit and an antenna 310, according to an embodiment.

Referring to FIG. 4, the heater assembly 200 may be arranged within the housing 100. The entire exterior of the heater assembly 200 may have a tube or cylinder shape having a cavity therein. The cavity of the heater assembly 200 may be referred to as the insertion space 100h, and the aerosol generating article S may be inserted into the insertion space 100h to be heated.

The heater assembly 200 may include a conductor 410 providing the cavity and a supporter 420 supporting the conductor 410. According to an embodiment, the heater assembly 200 may include an insulation member or a shielding member outside the conductor 410.

The supporter 420 may be coupled to the housing 100. The conductor 410 may be attached or press-fitted to the supporter 420. The insertion space 100h may be defined through the coupling of conductor 410 and the supporter 420. The conductor 410 may be coupled to the supporter 420 and may extend in the vertical direction of the aerosol generating device 1. At least a portion of an inner circumferential surface of the conductor 410 may come in contact with an outer circumferential surface of the aerosol generating article S inserted into the insertion space 100h. The conductor 410 may be manufactured of stainless steel, aluminum, or an alloy, but the disclosure is not limited thereto.

The antenna 310 may surround the at least a portion of the inner circumferential surface of the conductor 410. In an example, the antenna 310 may include a flexible patch antenna, and may be attached to the inner circumferential surface of the conductor 410. However, the disclosure is not limited thereto, and the antenna 310 may surround at least a portion of the outer circumferential surface of the conductor 410. In this state, the conductor 410 may further include a slot at a position where the antenna 310 is attached.

The antenna 310 may be arranged in a lower side of the conductor 410 (in a −z direction). The lower side of the disclosure may refer to a side facing in a direction opposite to an opening provided by the insertion space 100h. The antenna 310 may be spaced apart by a certain distance from the supporter 420 in the lower side of the conductor 410. When the antenna 310 is disposed in the distal direction of the opening, the external exposure of electromagnetic waves may be reduced.

The antenna 310 may radiate electromagnetic waves to the insertion space 100h. The aerosol generation rod SS of the aerosol generating article S may be heated by the electromagnetic waves radiated to the insertion space 100h. In an embodiment in which the aerosol generating article S is heated by using the resonance of electromagnetic waves, the conductor 410 and the supporter 420 may be referred to as a resonator.

As described above, as the conductor 410, the supporter 420, and the antenna 310 contribute to the heating of the aerosol generating article S, these components may be some components of the dielectric heating unit 17.

The moisture detection sensor 121 may surround the at least a portion of the outer circumferential surface of the conductor 410. In an example, the moisture detection sensor 121 may include a capacitive sensor, and the capacitive sensor may be manufactured to be flexible and attached to the outer circumferential surface of the conductor 410. As the moisture detection sensor 121 is arranged outside the conductor 410, not inside the conductor 410, noise due to the electromagnetic waves may be reduced.

The moisture detection sensor 121 may be arranged in an upper side of the conductor 410 (in a +z direction). The upper side of the disclosure may refer to a side facing in the direction of the opening provided by the insertion space 100h. The moisture detection sensor 121 may be spaced apart by a certain distance from the opening in the upper side of the conductor 410. The certain distance may be set based on the length of the aerosol generation rod SS. The moisture detection sensor 121 may be arranged at a position corresponding to a partial area of the aerosol generation rod SS on the outer circumferential surface of the conductor 410.

In an embodiment in which the moisture detection sensor 121 is a capacitive sensor, the permittivity of the moisture detection sensor 121 may vary depending on a change in moisture in the insertion space 100h. Accordingly, the number of charge/discharge cycles per unit time of the capacitive sensor may be variable. The control unit 10 may detect the change in the moisture in the insertion space 100h and/or the aerosol generating article S based on the number of charge/discharge cycles per unit time of the capacitive sensor. The control unit 10 may control the output of the source unit 20 based on the change in the moisture in the insertion space 100h and/or the aerosol generating article S. Furthermore, the control unit 10 may detect the insertion of the aerosol generating article S based on the change in the moisture in the insertion space 100h and/or the aerosol generating article S. Furthermore, the control unit 10 may identify the type of the aerosol generating article S based on the change in the moisture in the insertion space 100h and/or of the aerosol generating article S.

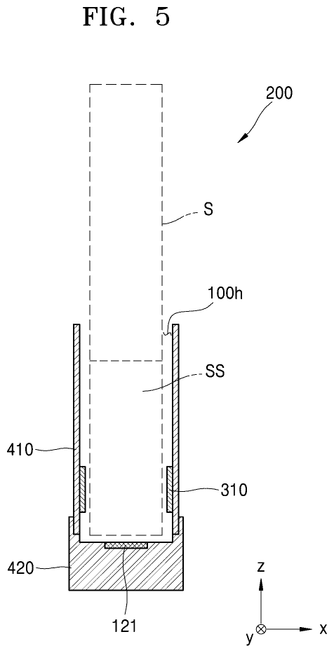

Unlike FIG. 5 described below, the moisture detection sensor 121 of FIG. 4 is arranged in the upper side of the conductor 410 adjacent to the opening. In such an arrangement, compared with a case in which the moisture detection sensor 121 is disposed in the lower side of the conductor 410, the change in the moisture in the insertion space 100h and/or the aerosol generating article S may be detected earlier. Furthermore, in such an arrangement, compared with a case in which the moisture detection sensor 121 is disposed in the lower side of the conductor 410, the change in the moisture in the insertion space 100h and/or of the aerosol generating article S may be detected over a longer duration. Accordingly, the arrangement in FIG. 4 may increase sensing accuracy in an embodiment in which the moisture detection sensor 121 also functions as an insertion detection sensor.

FIG. 5 is a cross-sectional view of a heater assembly for describing the arrangement of a sensing unit and an antenna, according to another embodiment.

FIG. 5 illustrates an example in which the moisture detection sensor 121 is arranged adjacent to the lower surface of the insertion space 100h. In FIGS. 4 and 5, like reference numerals denote like elements and redundant descriptions thereof are omitted.

Referring to FIG. 5, the moisture detection sensor 121 may be arranged below the insertion space 100h. The moisture detection sensor 121 may be arranged outside the insertion space 100h to be adjacent to the lower surface of the insertion space 100h with which the aerosol generating article S comes in contact. As the moisture detection sensor 121 is disposed outside the conductor 410, not inside the conductor 410, the noise due to electromagnetic waves may be reduced.

The moisture detection sensor 121 may be arranged inside the supporter 420 by an injection molding method. However, as long as the moisture detection sensor 121 is arranged adjacent to the lower surface of the insertion space 100h outside the insertion space 100h, the disclosure is not limited to such a manufacturing method.

Unlike FIG. 4, the moisture detection sensor 121 of FIG. 5 is arranged adjacent to the lower surface of the insertion space 100h in the opposite direction to the opening. In this state, the lower surface of the insertion space 100h may be an area in contact with the aerosol generating article S. As such, when the aerosol generating article S comes in contact with the lower surface of the insertion space 100h, in determining the change in the moisture of the aerosol generating article S, a sensing noise value due to moisture existing between the aerosol generating article S and the inner circumferential surface of the insertion space 100h may be reduced. In other words, the arrangement in FIG. 5 may be advantageous for determining the change in the moisture of the aerosol generating article S.

FIG. 6 is a graph for explaining a power control method and a frequency of a source unit corresponding to a change in moisture level of an aerosol generating article, according to an embodiment.

FIG. 6 shows a graph 610 indicating a change in the moisture level according to the heating of the aerosol generating article S. Furthermore, FIG. 6 shows a graph 620 indicating an output frequency of the source unit 20 and a graph 630 indicating an output power of the source unit 20 according to the change in the moisture of the aerosol generating article S. However, the graphs in FIG. 6 are examples for describing a control method according to the change in the moisture of the aerosol generating article S, and the inclination of each graph may vary depending on experiments.

Referring to FIG. 6, the moisture of the aerosol generating article S may be provided by glycerin (e.g.: vegetable glycerin (VG)) and/or propylene glycol (PG), a flavoring agent, or an organic acid. Th moisture may gradually decrease as the aerosol generating article S is heated.

As the moisture of the aerosol generating article S deceases, the control unit 10 may increase the output frequency of the source unit 20 and decrease the output power of the source unit 20.

In an example, the control unit 10 may obtain information about the moisture level of the aerosol generating article S from the sensing unit 12 at a first point t1. The control unit 10 may determine that the moisture level of the aerosol generating article S at the first point t1 is a first level s1. When the moisture level of the aerosol generating article S is determined to be the first level s1, the control unit 10 may adjust the output frequency of the source unit 20 to a first frequency f1 and the output power of the source unit 20 to a first power w1.

The control unit 10 may obtain the information about the moisture level of the aerosol generating article S from the sensing unit 12 at a second point t2 after the first point t1. The control unit 10 may determine that the moisture level of the aerosol generating article S at the second point t2 is a second level s2. When the moisture level of the aerosol generating article S is determined to be the second level s2, the control unit 10 may adjust the output frequency of the source unit 20 to a second frequency f2 and the output power of the source unit 20 to a second power w2. In this state, the second frequency f2 may be greater than the first frequency f1, and the second power w2 may be less than the first power w1.

FIG. 6 illustrates an example of controlling the output of the source unit 20 according to the change in the moisture level of the aerosol generating article S, and such control may be performed substantially in real time. In other words, a period between the first point t1 and the second point t2 may be set to be within 100 ms.

The output frequency and the output power of the source unit 20 according to the change in the moisture level of the aerosol generating article S may be determined according to experiments regardless of matching frequency. In detail, the directional coupler 240 may separate the RF signals transmitted from the radiating unit 30 and the reflected electromagnetic waves reflected from the insertion space 100h, and transmit the signals and waves to the control unit 10. The control unit 10 may analyze properties (e.g.: current, voltage, power, phase, and/or frequency) of the reflected electromagnetic waves. The control unit 10 may obtain the output frequency of the source unit 20 when the power of the reflected electromagnetic waves becomes minimum. As such, when the power of the reflected electromagnetic waves becomes minimum, the output frequency of the source unit 20 may be referred to as the matching frequency. In FIG. 6, the control unit 10 may adjust, independently of the matching frequency, the output frequency and the output power of the source unit 20 according to the moisture level of the aerosol generating article S. Information about the output frequency and output power of the source unit 20 corresponding to the moisture level, for each the aerosol generating article S, may be stored in the memory 15. The identification of the aerosol generating article S for the output control of the source unit 20 for each the aerosol generating article S may be implemented by the moisture detection sensor 121.

As such, the aerosol generating device 1 does not collectively increase or decrease both of the output frequency and the output power of the source unit 20 as the moisture level of the aerosol generating article S decreases, but increases the output frequency of the source unit 20 and decreases the output power of the source unit 20 as the moisture level decreases. Due to the complementary control of the output frequency and the output power of the source unit 20, while the consumption power of the aerosol generating device 1 may be reduced, the user smoking flavor sensation may be improved.

The aerosol generating article S may not meet the expected moisture content during the manufacturing, shipping, and storage stages. For example, the aerosol generating article S may fall short of or exceed the expected moisture content depending on the wet or dry environment. When the aerosol generating article S fails to meet the expected moisture content, the control unit 10 may be unable to identify the type of the aerosol generating article S. As such, when the control unit 10 is unable to identify the type of the aerosol generating article S, the control unit 10 may adjust the output frequency of the source unit 20 in real time according to the matching frequency obtained based on the reflected electromagnetic waves described above. In other words, the control unit 10 may adjust the output frequency of the source unit 20 so that the power of the reflected electromagnetic waves becomes minimum. Furthermore, when the control unit 10 is unable to identify the type of the aerosol generating article S, the control unit 10 may control the output power of the source unit 20 according to a preset power profile. For example, the preset control profile may include a first power for a first time period and a second power for a second time period after the first time period. In this state, the first time period and the second time period may be 10 seconds and 280 seconds, respectively, and the first power and the second power may be 10 w and 5 w, respectively, but the disclosure is not limited thereto.

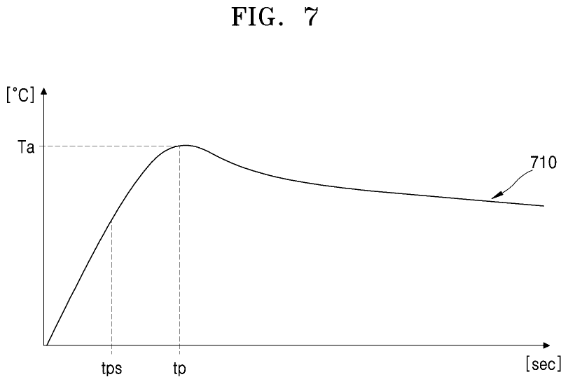

FIG. 7 is a graph showing an example of a heating profile for explaining a method of controlling a frequency and a power of a source unit in a partial section of a preheating section, according to an embodiment.

Referring to FIG. 7, a heating profile 710 may include a preheating section and a smoking section following the preheating section. For example, the control unit 10 may heat the aerosol generating article S to a target preheating temperature Ta equal to or higher than a vaporization temperature until a preset preheating time tp, and maintain the aerosol generating article S at a temperature equal to or higher than the vaporization temperature from the preheating time to an end time.

The end time may be determined based on a preset end time and/or the moisture level of the aerosol generating article S. In an embodiment considering both of the preset end time and the moisture level of the aerosol generating article S, when at least any one of an end time condition and an end level condition is satisfied, the control unit 10 may block the output of the source unit 20. For example, when 290 seconds elapse from the start of preheating, the control unit 10 may block the output of the source unit 20. Furthermore, when the moisture level of the aerosol generating article S is within a preset reference end level range, the control unit 10 may block the output of the source unit 20. In this state, a reference end level is set based on the volume ratio of moisture to the unit volume of a medium and may be selected within a range of 10%. The control unit 10 may automatically block the output of the source unit 20based on the moisture level of the aerosol generating article S only when the type of the aerosol generating article S is identified. In other words, the control unit 10 may block the output of the source unit 20 based on the preset end time when the type of the aerosol generating article S is not identified, and block the output of the source unit 20 based on the preset end time and the preset reference end level range when the type of the aerosol generating article S is identified.

The control unit 10 may increase the output frequency of the source unit 20 and decrease the output power of the source unit 20, corresponding to the decrease in the moisture level of the aerosol generating article S, in the entire section of the preheating section and the smoking section, as shown in FIG. 6. However, according to an embodiment, the control unit 10 may control the output of the source unit 20, in a partial section of the preheating section, by a different control method from the control method in FIG. 6.

In detail, the control unit 10 may perform the different control method from the control method in FIG. 6 in the initial section of the preheating section. The control unit 10 may adjust the output frequency of the source unit 20 to a third frequency that is greater than the first frequency and the second frequency, until a first sub-preheating time tps from the start of preheating, independently of the moisture level of the aerosol generating article S, and adjust the output power of the source unit 20 to a third power that is greater than the first power and the second power. The third frequency and the third power may be optimally determined through experiments, and the third frequency may be adjusted independently of the matching frequency as shown in FIG. 6. For example, the third frequency and the third power may be set in a range between 70% to 100% of the maximum output frequency and the maximum output power of the source unit 20. The control up to the first sub-preheating time tps, which is performed regardless of the moisture level of the aerosol generating article S, may be referred to as so-called forward control. On the contrary, the control after the first sub-preheating time tps, which is determined based on the moisture level of the aerosol generating article S, may be referred to as so-called feedback control.

As such, the aerosol generating device 1 controls the source unit 20 at a relatively high frequency and power during the first sub-preheating time tps, thereby facilitating rapid preheating.

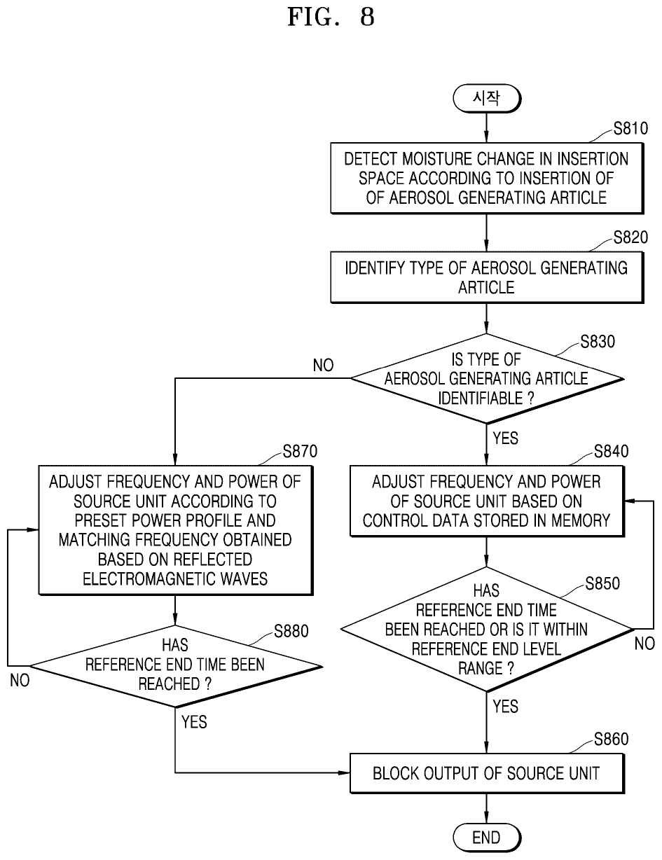

FIG. 8 is a flowchart for explaining an operation method of an aerosol generating device, according to an embodiment.

Referring to FIG. 8, in operation S810, the sensing unit 12 may detect the change in the moisture in the insertion space 100h according to the insertion of the aerosol generating article S.

The sensing unit 12 may include the moisture detection sensor 121, and the moisture detection sensor 121 may include a capacitive sensor. Accordingly, when the aerosol generating article S is inserted into the insertion space 100h, the permittivity of the moisture detection sensor 121 may vary. The control unit 10 may determine the insertion of the aerosol generating article S based on the change in the permittivity of the moisture detection sensor 121.

In operation S820, the control unit 10 may identify the type of the aerosol generating article S.

The aerosol generating article S may have a unique moisture content range, the control unit 10 may identify the aerosol generating article S based on the unique moisture content range. In this state, a unique moisture content may mean a moisture level included in the aerosol generating article S before the start of preheating. In an example, the memory 15 may store the unique moisture content range of the aerosol generating article S, and the control unit 10 may compare the data stored in the memory 15 with the moisture level of the aerosol generating article S detected by the sensing unit 12. The data about the moisture content stored in the memory 15 may be used for determining whether identification is possible in operation S830.

In operation S830, the control unit 10 may determine whether the type of the aerosol generating article S is identifiable.

When the moisture level detected by the sensing unit 12 is within the unique moisture content range stored in the memory 15, the control unit 10 may determine that the type of the aerosol generating article S is identifiable, and may perform operations S840 or any subsequent step.

The moisture content of the aerosol generating article S may change significantly depending on the surrounding environment during the manufacturing, shipping, and storage stages, even when the aerosol generating article S is manufactured by the same manufacturer. In other words, the aerosol generating article S may not meet the expected moisture content while passing through the manufacturing, shipping, and storage stages. As such, when the aerosol generating article S fails to meet the expected moisture content, the moisture level detected by the sensing unit 12 may not be within the unique moisture content range stored in the memory 15. When the moisture level detected by the sensing unit 12 is not within the unique moisture content range stored in the memory 15, the control unit 10 may determine that the identification of the type of the aerosol generating article S is impossible and perform operation S870 or any subsequent step.

In operation S840, when it is determined in operation S830 that the type of the aerosol generating article S is identifiable, the control unit 10 may adjust the frequency and the power of the source unit 20 based on control data stored in the memory 15.

In an embodiment, as the moisture of the aerosol generating article S decreases, the control unit 10 may increase the output frequency of the source unit 20 and decrease the output power of the source unit 20. However, target values of the output frequency and the output power may be set through experiments regardless of the matching frequency. The complementary control of the output frequency and the output power according to the decrease in the moisture of the aerosol generating article S may be performed in the entire section of the preheating section and the smoking section.

According to an embodiment, the control unit 10 may perform the complementary control of the output frequency and the output power according to the decrease in the moisture of the aerosol generating article S in a partial section of the preheating section and the entire smoking section. The control unit 10 may fix the output frequency and the output power of the source unit 20 in the initial section of the preheating section regardless of the moisture level of the aerosol generating article S. For example, the control unit 10 may set the output frequency and the output power in a range of 70% to 100% of the maximum output frequency and the maximum output power of the source unit 20. This is to facilitate rapid preheating.

In operation S850, the control unit 10 may determine whether the reference end time has been reached or whether the moisture level of the aerosol generating article S is within the reference end level range.

The control unit 10 may include a timer and monitor the time elapsed from the start point of preheating. When a preset reference end time does not elapse from the start point of preheating, the control unit 10 may perform operation S840 again. Alternatively, when the preset reference end time has elapsed from the start point of preheating, in operation S860, the control unit 10 may block the output of the source unit 20.

Alternatively, the memory 15 may store the reference end level for the moisture level of the aerosol generating article S to stop the heating. The sensing unit 12 may transmit in real time the change in the moisture of the aerosol generating article S to the control unit 10, and the control unit 10 may perform operation S840 until the moisture level of the aerosol generating article S is within a preset reference end level range. When the moisture level of the aerosol generating article S is within the preset reference end level range, in operation S860, the control unit 10 may block the output of the source unit 20.

As such, if the type of the aerosol generating article S is identified, the control unit 10 may block the output of the source unit 20 when either a reference end time condition or an end level condition is satisfied.

In operation S870, when it is determined in operation S830 that the identification of the type of the aerosol generating article S is impossible, the control unit 10 may adjust the frequency and the power of the source unit 20 according to the preset power profile and the matching frequency obtained based on the reflected electromagnetic waves.

In an embodiment, the control unit 10 may track in real time the matching frequency of the source unit 20 at which the power of the reflected electromagnetic waves becomes minimum, and adjust the output frequency of the source unit 20 based on the matching frequency.

Furthermore, while adjusting the output frequency of the source unit 20 according to the matching frequency, the control unit 10 may control the output power of the source unit 20 according to the preset power profile. For example, the preset power profile may include the first power for the first time period and the second power for the second time period after the first time period.

In operation S880, the control unit 10 may determine whether the reference end time has been reached.

Unlike operation S850, the control unit 10 may only determine whether the reference end time is satisfied when it is unable to identify the type of the aerosol generating article S. This is because, when the type of the aerosol generating article S is unable to identified, it is impossible to control the output frequency and the output power of the source unit 20 according to the moisture change.

When the preset reference end time does not elapse from the start point of preheating, the control unit 10 may perform operation S870 again. Alternatively, when the preset reference end time elapses from the start point of preheating, the control unit 10 may block the output of the source unit 20, as in operation S860.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

The aerosol generating device of the disclosure may directly obtain the moisture level of the aerosol generating article from the separate moisture detection sensor and adjust the frequency and the power of the source unit according to a change in moisture level of the aerosol generating article. In particular, as the frequency and the power according to the moisture level may be set through experiments considering the user's smoking flavor sensation, thereby increasing user satisfaction.

Furthermore, the aerosol generating device does not collectively increase or decrease both of the output frequency and the output power of the source unit as the moisture level of the aerosol generating article decreases, but increases the output frequency of the source unit and decreases the output power of the source unit as the moisture level decreases. Due to the complementary control of the output frequency and the output power of the source unit, while the consumption power of the aerosol generating device may be reduced, the user smoking flavor sensation may be improved.

Furthermore, according to an embodiment, the aerosol generating device may operate the frequency and the power of the source unit, at the maximum output, in the initial section of the preheating section. Accordingly, user satisfaction is increased by rapid preheating.

Furthermore, as the moisture detection sensor of the aerosol generating device performs even functions of the insertion detection and type identification of the aerosol generating article, there is no need for additional detection sensors.

Furthermore, when the aerosol generating article falls short of or exceeds the expected moisture content during the manufacturing, shipping, and storage stages, the aerosol generating device may control the source unit in real time according to the matching frequency, not the preset control profile. Accordingly, even aerosol generating articles that do not satisfy a certain reference may not significantly impair user smoking flavor sensation.

The effects of the disclosure are not limited to the contents disclosed herein, and other various effects may be further included in the disclosure.

What is claimed is:

1. An aerosol generating device comprising:
a source unit configured to generate a radio frequency (RF) signal;
a radiating unit configured to heat the aerosol generating article by radiating the RF signal in a form of electromagnetic waves to an insertion space into which an aerosol generating article is inserted;
a sensing unit configured to detect a change in moisture of the aerosol generating article according to the heating by the radiating unit; and
a control unit configured to control a frequency and a power of the RF signal output by the source unit, based on the change in moisture of the aerosol generating article.

2. The aerosol generating device of claim 1, wherein the sensing unit is further configured to detect the change in moisture of the aerosol generating article in a preheating section and a smoking section following the preheating section, and transmit a detection result to the control unit, and
the control unit is further configured to: in at least a portion of the preheating section and the smoking section, control the frequency and the power of the RF signal output by the source unit; based on a moisture level of the aerosol generating article being determined to be a first level, adjust an output frequency and an output power of the source unit to a first frequency and a first power, respectively; and based on the moisture level of the aerosol generating article being determined to be a second level less than the first level, adjust the output frequency and the output power of the source unit to a second frequency greater than the first frequency and a second power less than the first power, respectively.

3. The aerosol generating device of claim 2, wherein the control unit is further configured to, in at least a portion of the preheating section, independently of a detection result of the sensing unit, adjust the output frequency of the source unit to a third frequency greater than the first frequency and the second frequency, and adjust the output power of the source unit to a third power greater than the first power and the second power.

4. The aerosol generating device of claim 3, further comprising a directional coupler configured to receive reflected electromagnetic waves reflected from the insertion space,
wherein the control unit is further configured to, based on a power of the reflected electromagnetic waves being within a reference power range, set the first frequency, the second frequency, and the third frequency, independently of a matching frequency output by the source unit.

5. The aerosol generating device of claim 1, wherein the control unit is further configured to, based on a moisture level of the aerosol generating article being within a preset reference end level range, block output of the source unit.

6. The aerosol generating device of claim 1, wherein the sensing unit is further configured to detect a change in moisture in the insertion space according to insertion of the aerosol generating article, and
the control unit is further configured to identify a type of the aerosol generating article, based on the change in moisture in the insertion space.

7. The aerosol generating device of claim 6, further comprising a memory storing information about an output frequency and an output power of the source unit corresponding to a moisture level for each aerosol generating article.

8. The aerosol generating device of claim 7, wherein the control unit is further configured to, based on the type of the aerosol generating article being unidentifiable, adjust the output frequency of the source unit according to a matching frequency obtained based on reflected electromagnetic waves.

9. The aerosol generating device of claim 1, wherein the sensing unit comprises at least one capacitive sensor, and
the control unit is further configured to detect the change in moisture of the aerosol generating article, based on a number of charge/discharge cycles per unit time of the at least one capacitive sensor.

10. The aerosol generating device of claim 9, wherein the at least one capacitive sensor is manufactured to be flexible, and surrounds at least a portion of an outer circumferential surface of the insertion space.

11. The aerosol generating device of claim 9, wherein the capacitive sensor is arranged adjacent to a lower surface of the insertion space with which the aerosol generating article comes into contact.
